(19) United States
(12) Patent Application Publication
(10) Pub. No.: US 2025/0388779 A1
(43) Pub. Date: Dec. 25, 2025

(54) SELF-HEALING POLYURETHANE-BASED COATING COMPOSITION, POLYURETHANE-BASED COATING FILM INCLUDING SAME, AND METHODS OF MANUFACTURING THE COATING COMPOSITION AND THE COATING FILM

(71) Applicants: Hyundai Motor Company, Seoul (KR); Kia Corporation, Seoul (KR); Korea Research Institute of Chemical Technology, Daejeon (KR)

(72) Inventors: Jae Sik Seo, Hwaseong (KR); Chan Wook Park, Hwaseong (KR); Hyeon Yeol Jeon, Daejeon (KR); Je Young Park, Daejeon (KR); Dong Yeop Oh, Daejeon (KR); Se Bin Jin, Daejeon (KR)

(21) Appl. No.: 18/936,625

(22) Filed: Nov. 4, 2024

(30) Foreign Application Priority Data
Jun. 19, 2024 (KR) 10-2024-0079731

(51) Int. Cl. C09D 175/14; C09D 7/63

(52) U.S. Cl. CPC C09D 175/14; C09D 7/63

(57) ABSTRACT

A self-healing polyurethane-based coating composition, a polyurethane-based coating film including the same, and methods of manufacturing the coating composition and the coating film, in which design of an oligomer containing a disulfide functional group is capable of achieving self-healing performance at room temperature and ensuring appropriate fluidity, whereby a coating film can be manufactured by spraying. The composition further includes a polyisocyanate hardener, and the oligomer is formed by polymerizing a carbonate-type diol, an alicyclic isocyanate, and an aromatic disulfide-type diol. This specific molecular design provides high self-healing efficiency, enhanced optical transparency, and excellent mechanical stability. The coating film achieves a self-healing efficiency of 80% or more, a transmission rate of 85% or higher, and a sagging rate of 5% or less. The manufacturing process controls the molar ratios of hydroxyl (—OH) to isocyanate (—NCO) groups, optimizing cross-linking and ensuring durability in the final coating.

### CROSS-REFERENCE TO RELATED APPLICATION

This application claims, under 35 U.S.C. § 119(a), the benefit of Korean Patent Application No. 10-2024-0079731, filed on Jun. 19, 2024, the entire contents of which are incorporated herein by reference.

### BACKGROUND

### Technical Field

The present disclosure relates to a self-healing polyurethane-based coating composition, a polyurethane-based coating film including the same, and methods of manufacturing the coating composition and the coating film. The composition features an oligomer containing a disulfide functional group is capable of achieving self-healing performance at room temperature while maintaining appropriate fluidity for spray application. The oligomer is synthesized from a carbonate-type diol, an aromatic disulfide-type diol, and an alicyclic isocyanate-type compound, ensuring optimal mechanical properties. The resulting coating film exhibits high self-healing efficiency, excellent transparency, and low sagging, making it suitable for durable applications.

### Background

Polyurethane-based coatings are used in various industrial fields and are particularly 20 common in finishing materials, adhesives, and sealants. These coatings are often applied to protect the surface of plastics used as interior and exterior materials in automobiles.

The surface properties of polyurethane-based coatings tend to have high hardness and rigidity, which is intended to improve molecular weight, cross-linking density, etc. to ensure durability against impacts, scratches, and chemicals that may occur during the use of a coating material. Generally, a polyurethane-based coating is obtained by applying a polyurethane-based coating composition onto a coating material followed by drying. When the surface hardness of the polyurethane-based coating is excellent due to high molecular weight and cross-linking density thereof, the flow properties of the polyurethane-based coating composition may comparatively significantly deteriorate.

Recently, thorough research into polyurethane-based coating compositions having self-healing properties is ongoing. Here, “self-healing properties” may mean the properties of returning to a clean scratch-free original state by self-recovery when a scratch occurs on a coating film to which the polyurethane-based coating composition is applied. Self-healing properties are classified into extrinsic-type or intrinsic-type depending on the mechanism of action thereof. In case of extrinsic-type self-healing properties, heterogeneity between interfaces appears at the restoration site, and continuous restoration may be difficult due to exhaustion of microcapsules that cause self-healing properties.

Regarding polyurethane-based coating compositions having intrinsic-type self-healing properties, there is known a method of exhibiting self-healing properties by blending two or more polymers having different glass transition temperatures (Tg) to develop fluidity under high temperature conditions. However, this method is problematic in that it is only effective for fine scratches, has little effect on complete cutting, and does not exhibit self-healing properties at room temperature.

### SUMMARY OF THE DISCLOSURE

Therefore, the present disclosure has been made keeping in mind the problems encountered in the related art, and an object of the present disclosure is to provide a polyurethane-based coating composition that exhibits self-healing properties even at room temperature without a separate external heat source, a coating film including the same, and methods of manufacturing the coating composition and the coating film.

Another object of the present disclosure is to provide a polyurethane-based coating composition that exhibits excellent fluidity and surface hardness in a balanced manner without an excessive increase in the thickness of a coating film, a coating film including the same, and methods of manufacturing the coating composition and the coating film.

The objects of the present disclosure are not limited to the foregoing. The objects of the present disclosure will be able to be clearly understood through the following description and to be realized by the means described in the claims and combinations thereof.

An aspect of the present disclosure provides a polyurethane-based coating composition, including a main resin including an oligomer comprising a) a disulfide functional group (R—S—S—R′) and a hydroxyl group (—OH), wherein R and R′ are each independently a substituted or unsubstituted C6-C30 arylene group; and b) a hardener including polyisocyanate.

In one embodiment, the oligomer may include a polymer of a carbonate-type diol, an alicyclic isocyanate-type compound, and an aromatic disulfide-type diol.

In one embodiment, the oligomer may be represented by Chemical Formula 1 below.

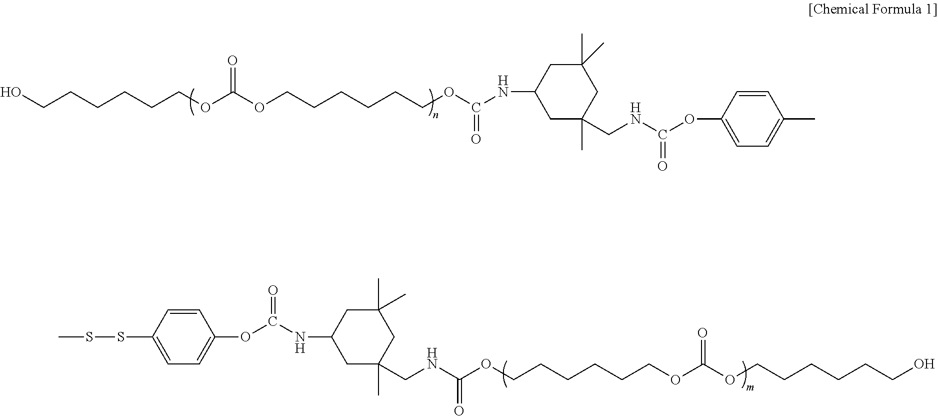

Wherein in Chemical Formula 1 n and m are integers of 1 or more indicating repetition numbers of respective repeat units.

In one embodiment, a molar ratio [—OH]/[—NCO]) of a hydroxyl group (—OH) of the carbonate-type diol and the aromatic disulfide-type diol to an isocyanate group (—NCO) of the alicyclic isocyanate-type compound may satisfy about 1.05≤[—OH]/[—NCO]≤about 1.5.

In one embodiment, the carbonate-type diol may have a number average molecular weight of about 500 to 5,000 g/mol.

In one embodiment, the carbonate-type diol may include poly(hexamethylene carbonate).

In one embodiment, the aromatic disulfide-type diol may be represented by Chemical Formula 2 below.

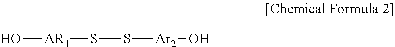

In Chemical Formula 2, Ar₁ and Ar₂ are each independently a substituted or unsubstituted C6-C30 arylene group.

In one embodiment, the aromatic disulfide-type diol may include bis(4-hydroxyphenyl) disulfide.

In one embodiment, the alicyclic isocyanate-type compound may include any one selected from the group consisting of isophorone diisocyanate, 4,4′-dicyclohexylmethane diisocyanate, cyclohexylene diisocyanate, methylcyclohexylene diisocyanate, bis(2-isocyanatoethyl)-4-dichlorohexene-1,2-dicarboxylate, 2,5-norbornane diisocyanate, 2,6-norbornane diisocyanate, and combinations thereof.

In one embodiment, a molar ratio ([—OH]/[—NCO]) of a hydroxyl group (—OH) of the main resin to an isocyanate group (—NCO) of the hardener may satisfy about 0.9≤[—OH]/[—NCO]≤about 1.1.

In one embodiment, the main resin and the hardener may be included at a mass ratio of about 1:0.16 to about 1:0.24.

In one embodiment, the hardener may include methylene diphenyl diisocyanate and isophorone diisocyanate.

In one embodiment, a mass ratio of methylene diphenyl diisocyanate to isophorone diisocyanate in the hardener may be about 7:3 to 3:7.

Another aspect of the present disclosure provides a polyurethane-based coating film, including the polyurethane-based coating composition described above.

In one embodiment, a thickness of the polyurethane-based coating film may be about 10 to 200 μm.

In one embodiment, the polyurethane-based coating film may have self-healing efficiency of about 80% or more as represented by Equation 1 below.

$$Self - healing efficiency ( \% ) = ( width of scratch - width of scratch after self - healing ) / width of scratch \times 100 \qquad [ Equation 1 ]$$

In one embodiment, the polyurethane-based coating film may have a transmission of about 85% or more as represented by Equation 2 below.

$$Transmission ( \% ) = ( {10}^{- absorbance} ) \times 100 \qquad [ Equation 2 ]$$

In one embodiment, the polyurethane-based coating film may have a sagging of about 5% or less as represented by Equation 3 below.

$$Sagging ( \% ) = ( thickness of bottom of coating film after 7 days - thickness of bottom of initial coating film ) / thickness of bottom of initial coating film \times 100 \qquad [ Equation 3 ]$$

In addition, a polyurethane-based coating film according to the present disclosure may be manufactured by applying the polyurethane-based coating composition by spraying.

In some embodiments, a polyurethane-based coating composition is provided. The composition includes a resin comprising an oligomer comprising a disulfide functional group and a hydroxyl group; and a hardener including polyisocyanate. The oligomer comprises a polymer of poly(hexamethylene carbonate), bis(4-hydroxylphenyl) disulfide, and the hardener comprises methylcyclohexylene diisocyanate, and isophorone diisocyanate. A mass ratio of methylcyclohexylene diisocyanate to isophorone diisocyanate is about 7:3 to 3:7.

In some embodiments, a polyurethane-based coating composition is provided. The composition includes a resin comprising an oligomer comprising a disulfide functional group (R—S—S—R′) and a hydroxyl group (—OH); and a hardener including polyisocyanate. R and R′ are each independently a substituted or unsubstituted C6-C30 arylene group. The oligomer comprises a polymer of a carbonate-type diol, an alicyclic isocyanate-type compound, and an aromatic disulfide-type diol. A molar ratio [—OH]/[—NCO]) of a hydroxyl group (—OH) of the carbonate-type diol and the aromatic disulfide-type diol to an isocyanate group (—NCO) of the alicyclic isocyanate-type compound satisfies about 1.05≤[—OH]/[—NCO]≤about 1.5, and a molar ratio ([—OH]/[—NCO]) of a hydroxyl group (—OH) of the resin to an isocyanate group (—NCO) of the hardener satisfies about 0.9≤[—OH]/[—NCO]≤about 1.1.

Still another aspect of the present disclosure provides a method of manufacturing a polyurethane-based coating composition, including preparing a carbonate-type diol, an alicyclic isocyanate-type compound, and an aromatic disulfide-type diol, synthesizing a prepolymer by reacting the alicyclic isocyanate-type compound with the aromatic disulfide-type diol, synthesizing an oligomer by reacting the prepolymer with the carbonate-type diol, and manufacturing a polyurethane-based coating composition by mixing a main resin including the oligomer with a hardener including polyisocyanate.

In one embodiment, synthesizing the prepolymer may include reacting a first solution including the alicyclic isocyanate-type compound, dibutyltin dilaurate, and dimethylacetamide with a second solution including the aromatic disulfide-type diol, dibutyltin dilaurate, and dimethylacetamide.

In one embodiment, the prepolymer may be represented by Chemical Formula 3 below.

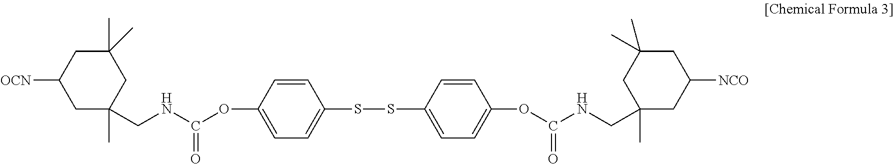

As discussed, the method and system suitably include use of a controller or processer. In another embodiment, vehicles are provided that comprise one or more coating compositions and/or an apparatus as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows the expected structural formula of an oligomer according to the present disclosure;

FIG. 2 shows a difference in properties depending on the molar ratio of a main resin and a hardener in a coating composition;

FIG. 3 shows results for a coating composition including the main resin and the hardener mixed at a mass ratio of 1:0.175;

FIG. 4 shows results for a coating composition including the main resin and the hardener mixed at a mass ratio of 1:0.2;

FIG. 5 shows results for a coating composition including the main resin and the hardener mixed at a mass ratio of 1:0.225;

FIG. 6 shows results of the self-healing time and self-healing efficiency of coating films 1 to 3 using only MDI as a hardener;

FIG. 7 shows results of the self-healing time and self-healing efficiency of coating film 4 using only IPDI as a hardener and having a thickness of 35 to 45 μm;

FIG. 8 shows results of the self-healing time and self-healing efficiency of coating film 5 using only IPDI as a hardener and having a thickness of 70 to 90 μm;

FIG. 9 shows results of the self-healing time and self-healing efficiency of coating film 6 using only IPDI as a hardener and having a thickness of 105 to 135 μm;

FIG. 10 shows results of the self-healing time and self-healing efficiency of coating film 7 using a mixture of MDI and IPDI at a weight ratio of 1:1 as a hardener and having a thickness of 35 to 45 μm;

FIG. 11 shows results of the self-healing time and self-healing efficiency of coating film 8 using a mixture of MDI and IPDI at a weight ratio of 1:1 as a hardener and having a thickness of 70 to 90 μm;

FIG. 12 shows results of the self-healing time and self-healing efficiency of coating film 9 using a mixture of MDI and IPDI at a weight ratio of 1:1 as a hardener and having a thickness of 105 to 135 μm; and

FIG. 13 is a graph showing the transmission of coating films 10, 13, and 14.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

The present disclosure relates to a polyurethane-based coating composition that exhibits self-healing properties even at room temperature without a separate external heat source, a coating film including the same, and methods of manufacturing the coating composition and the coating film. In addition, the present disclosure relates to a polyurethane-based coating composition that exhibits excellent fluidity and surface hardness in a balanced manner without an excessive increase in the thickness of a coating film, a coating film including the same, and methods of manufacturing the coating composition and the coating film.

### Polyurethane-Based Coating Composition

An aspect of the present disclosure provides a polyurethane-based coating composition, which includes a main resin including an oligomer containing a disulfide functional group (R—S—S—R′) and a hydroxyl group (—OH) and a hardener including polyisocyanate. As such, R and R′ are each independently a substituted or unsubstituted C6-C30 arylene group.

When the oligomer containing a disulfide functional group is included in the main resin in this way, a polyurethane-based coating composition capable of self-healing at room temperature without additional heat treatment or light irradiation may be provided. Here, “room temperature” does not necessarily mean 25° C., but may mean the temperature of an environment in which an article to which a coating composition or a coating film is applied is typically used. For example, room temperature may indicate 10° C. to 45° C.

More specifically, the oligomer may include a polymer of a carbonate-type diol, an alicyclic isocyanate-type compound, and an aromatic disulfide-type diol (C-IPSS; carbonate-type, isophorone, disulfide).

In one embodiment, the oligomer, which is the polymer of the carbonate-type diol, the alicyclic isocyanate-type compound, and the aromatic disulfide-type diol, may be represented by Chemical Formula 1 below.

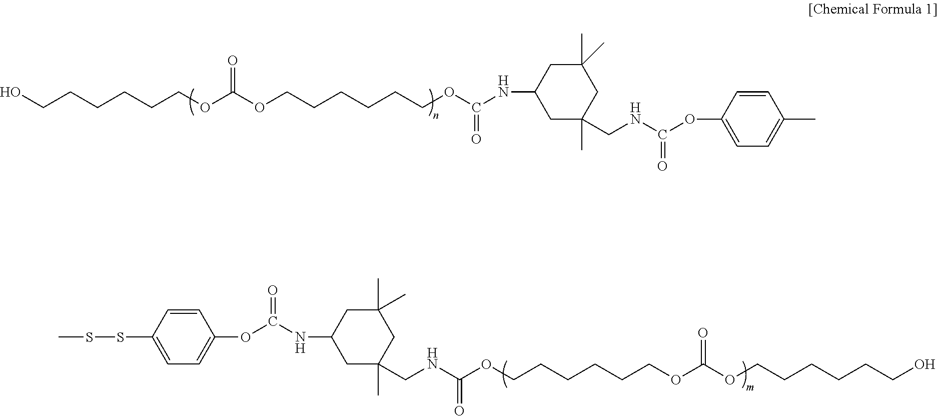

Here, n and m are integers of 1 or more indicating the repetition numbers of respective repeat units.

The oligomer represented by Chemical Formula 1 may be an example of the oligomer according to the present disclosure, and any oligomer may be used without particular limitation, 20 in addition to Chemical Formula 1, so long as it is an addition polymer having a carbonate-type diol as a soft segment and a monomer combination of an aromatic disulfide-type diol and an alicyclic isocyanate-type compound as a hard segment, with-OH groups at both ends thereof.

The carbonate-type diol may serve as a soft segment in the oligomer and may be a carbonate-type compound containing two hydroxyl groups (—OH). Preferably, the carbonate-type diol includes poly(hexamethylene carbonate) (HPCD) represented below.

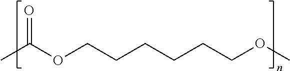

In one embodiment, the carbonate-type diol may have a number average molecular weight of 500 to 5,000 g/mol. When the number average molecular weight of the carbonate-type diol is 500 to 5,000 g/mol, ductility and elasticity of the polyurethane-based coating composition and the coating film including the same may be maximized, thereby minimizing the possibility of occurrence of defects such as cracks, etc. during the hardening process. Accordingly, coating efficiency may be improved.

The alicyclic isocyanate-type compound may be used without particular limitation so long as it is an alicyclic compound having two or more isocyanate groups, and a specific example thereof may include any one selected from the group consisting of isophorone diisocyanate, 4,4′-dicyclohexylmethane diisocyanate, cyclohexylene diisocyanate, methylcyclohexylene diisocyanate, bis(2-isocyanatoethyl)-4-dichlorohexene-1,2-dicarboxylate, 2,5-norbornane diisocyanate, 2,6-norbornane diisocyanate, and combinations thereof. In particular, isophorone diisocyanate (IPDI) is preferably included in view of ensuring high toughness.

The aromatic disulfide-type diol may be a compound containing an aromatic disulfide group (—Ar—S—S—Ar—) in the chemical structure thereof and two hydroxyl groups (—OH) at both ends thereof, and may be represented by Chemical Formula 2 below.

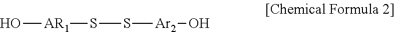

In Chemical Formula 2, Ar₁ and Ar₂ are each independently a substituted or unsubstituted C6-C30 arylene group.

The aromatic disulfide-type diol represented by Chemical Formula 2 may include, for example, bis(4-hydroxyphenyl) disulfide.

The polyurethane-based coating composition according to the present disclosure and the coating film including the same are capable of self-healing at room temperature without additional heat treatment or light irradiation by using the aromatic disulfide-type diol and the alicyclic isocyanate as monomer components of the oligomer polymer. Such properties of the polyurethane-based coating composition may be due to metathesis or dynamic bonding of the disulfide group contained in the disulfide-type diol.

Generally, the urethane group has —NCO and —OH at a ratio of 1:1. However, since the oligomer according to the present disclosure is configured such that a urethane group is contained and —OH groups are located at both ends of the oligomer, the equivalence ratio or molar ratio of —NCO and —OH may be intentionally adjusted. Here, the urethane group means a urethane group present in the main chain of the oligomer, not formed by reaction of the main resin and the hardener.

For reference, since —NCO and —OH groups contained in the urethane group generally react 1:1, the molar ratio to equivalence ratio used in this specification may have the same meaning.

In one embodiment, the molar ratio ([—OH]/[—NCO]) of the hydroxyl group (—OH) of the carbonate-type diol and the aromatic disulfide-type diol to the isocyanate group (—NCO) of the alicyclic isocyanate-type compound may satisfy 1.05≤[—OH]/[—NCO]≤1.5. When the equivalent of —OH is intentionally set to be higher than the equivalent of —NCO in the oligomer in this way, —OH groups may be located at both ends of the oligomer, which is a polymer thereof. Accordingly, it is possible to achieve not only self-restoration at room temperature but also excellent solvent resistance, wear resistance, and high transparency, which are fundamental features of a coating film.

If the molar ratio ([—OH]/[—NCO]) of the hydroxyl group (—OH) of the carbonate-type diol and the aromatic disulfide-type diol to the isocyanate group (—NCO) of the alicyclic isocyanate-type compound is less than 1.05, —OH groups may not be located at both ends of the oligomer. On the other hand, if the molar ratio thereof exceeds 1.5, the proportion of-NCO may be too low and mechanical properties of a final product to which the polyurethane-based coating composition is applied may be seriously deteriorated.

The polyurethane-based coating composition according to the present disclosure corresponds to a thermosetting coating material. Specifically, polyurethane may be formed by addition polymerization reaction of-OH of the oligomer contained in the main resin and —NCO of the polyisocyanate contained in the hardener.

The molar ratio ([—OH]/[—NCO]) of the hydroxyl group (—OH) of the main resin to the isocyanate group (—NCO) of the hardener may satisfy 0.9≤[—OH]/[—NCO]≤1.1. The molar ratio ([—OH]/[—NCO]) of the hydroxyl group (—OH) of the main resin to the isocyanate group (—NCO) of the hardener may be understood as the ratio of the total equivalent of-OH groups contained in the oligomer in the main resin to the total equivalent of-NCO groups contained in the polyisocyanate in the hardener.

When the molar ratio ([—OH]/[—NCO]) of the hydroxyl group (—OH) of the main resin to the isocyanate group (—NCO) of the hardener satisfies 0.9≤[—OH]/[—NCO]≤1.1, a coating composition that exhibits high self-healing ability and is not sticky may be obtained.

In one embodiment, the coating composition may include the main resin and the hardener at a mass ratio of 1:0.16 to 1:0.24. More preferably, the coating composition includes the main resin and the hardener at a mass ratio of 1:0.175 to 1:0.225. If the mass ratio of the main resin to the hardener is 1:0.15 or less, the coating composition may be too sticky. Specifically, the coating composition may have poor fluidity, making it difficult to use the same as a thermosetting coating composition. On the other hand, if the mass ratio of the main resin to the hardener is 1:0.25 or more, self-healing properties may not be exhibited due to an excess of the hardener.

When the coating composition includes the main resin and the hardener at a mass ratio of 1:0.175 to 1:0.225, self-healing ability and non-stickiness may be best exhibited.

Meanwhile, the weight ratio of the main resin to the hardener is calculated based on the oligomer in the main resin and the polyisocyanate in the hardener, and thus, when an organic solvent or a catalyst is additionally added to the coating composition, the weight ratio may vary.

In one embodiment, the polyisocyanate of the hardener may include methylene diphenyl diisocyanate (MDI) and isophorone diisocyanate (IPDI). If the hardener includes methylene diphenyl diisocyanate alone, it may be difficult to exhibit self-healing properties at room temperature. On the other hand, if the hardener includes isophorone diisocyanate alone, it may be difficult to maintain the hardened form due to excessive sagging.

In one embodiment, the mass ratio of methylene diphenyl diisocyanate to isophorone diisocyanate in the hardener may be 7:3 to 3:7. If the mass ratio of methylene diphenyl diisocyanate to isophorone diisocyanate in the hardener falls outside 7:3 to 3:7 and the amount of methylene diphenyl diisocyanate is higher, not only self-healing properties may decrease, but also self-healing properties at room temperature may not be exhibited. On the other hand, if the mass ratio of methylene diphenyl diisocyanate to isophorone diisocyanate in the hardener falls outside the above numerical range and the amount of isophorone diisocyanate is higher, it may be difficult to maintain the hardened form due to excessive sagging.

### Polyurethane-Based Coating Film

Another aspect of the present disclosure provides a polyurethane-based coating film including the polyurethane-based coating composition. The polyurethane-based coating film is formed on a coating material. As such, the coating material simply serves to support the coating film and may be used without particular limitation so long as it is commonly used in the art.

In one embodiment, the thickness of the polyurethane-based coating film may be 10 to 200 μm. The coating film according to the present disclosure may have excellent fluidity and surface hardness in a balanced manner without an excessive increase in the thickness thereof.

In one embodiment, the polyurethane-based coating film may have self-healing efficiency of 80% or more as represented by Equation 1 below.

$$Self - healing efficiency ( \% ) = ( width of scratch - width of scratch after self - healing ) / width of scratch \times 100 \qquad [ Equation 1 ]$$

More specifically, the self-healing efficiency is a value determined by forming a scratch with a width of 30 to 70 μm on the surface of a film-shaped coating composition or a coating film and then observing the recovered width by exposure to a temperature of 30° C. for 20 hours using an optical microscope.

In one embodiment, the polyurethane-based coating film may have a transmission of 85% or more as represented by Equation 2 below.

$$Transmission ( \% ) = ( {10}^{- absorbance} ) \times 100 \qquad [ Equation 2 ]$$

More specifically, the transmission may be determined by placing a coating film on a clear slide glass, measuring the absorbance of the coating film at a wavelength of 500 nm using a UV-VIS spectrophotometer, and then converting the same into a transmission according to Equation 2.

In one embodiment, the polyurethane-based coating film may have a sagging of 5% or less as represented by Equation 3 below.

$$Sagging ( \% ) = ( Thickness of bottom of coating film after 7 days - thickness of bottom of initial coating film ) / thickness of bottom of initial coating film \times 100 \qquad [ Equation 3 ]$$

More specifically, the sagging may be determined by measuring a change in thickness at the bottom of the coating film after placing the coating film that is manufactured and dried at an angle of 60° followed by leaving at a temperature of 80° C. for one week.

As described above, the coating film manufactured using the coating composition according to the present disclosure has self-healing efficiency at room temperature, transmission, and sagging, all of which are excellent in a balanced manner.

Meanwhile, the coating composition included in the coating film is substantially the same as that described in the “Polyurethane-based coating composition” above, and thus a redundant description thereof will be omitted.

### Methods of Manufacturing the Coating Composition and the Coating Film

Still another aspect of the present disclosure provides a method of manufacturing a polyurethane-based coating composition, including preparing a carbonate-type diol, an alicyclic isocyanate-type compound, and an aromatic disulfide-type diol, synthesizing a prepolymer by reacting the alicyclic isocyanate-type compound with the aromatic disulfide-type diol, synthesizing an oligomer by reacting the prepolymer with the carbonate-type diol, and manufacturing a polyurethane-based coating composition by mixing a main resin including the oligomer with a hardener including polyisocyanate.

Below is a detailed description of individual steps.

Specifically, a carbonate-type diol, an alicyclic isocyanate-type compound, and an aromatic disulfide-type diol are prepared. Here, the carbonate-type diol, the alicyclic isocyanate-type compound, and the aromatic disulfide-type diol are the same as those described in the “Polyurethane-based coating composition” above.

Accordingly, the type and amount of each diol or compound prepared in this step may be the same as those of the carbonate-type diol, alicyclic isocyanate-type compound, and aromatic disulfide-type diol described above. In addition, these compounds may be prepared to satisfy the molar ratio ([—OH]/[—NCO]) of the hydroxyl group (—OH) of the carbonate-type diol and the aromatic disulfide-type diol to the isocyanate group (—NCO) of the alicyclic isocyanate-type compound.

In one embodiment, the prepared carbonate-type diol may be purged at a temperature of 90° C. to 110° C. to completely remove residual water therefrom. The purging time is not particularly limited, so long as it is sufficient to completely remove residual water.

Thereafter, a prepolymer is synthesized by reacting the alicyclic isocyanate-type compound and the aromatic disulfide-type diol.

In one embodiment, synthesizing the prepolymer may include preparing a first solution by adding the alicyclic isocyanate-type compound to a solvent together with a catalyst, preparing a second solution by adding the aromatic disulfide-type diol to a solvent together with a catalyst, and mixing and reacting the first solution and the second solution.

The catalyst is not particularly limited, but may include, for example, dibutyltin dilaurate (DBTDL). Also, the solvent is not particularly limited but may include dimethylacetamide (DMAc).

The process of synthesizing the prepolymer may be carried out under a nitrogen (N₂) atmosphere.

The prepolymer thus synthesized may be represented by Chemical Formula 3 below.

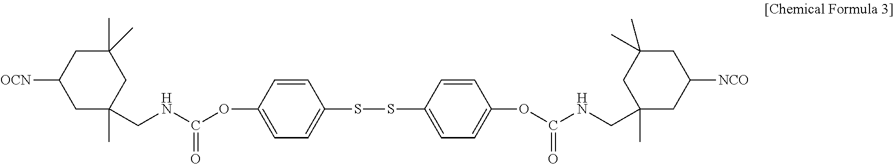

Chemical Formula 3 represents an example of the prepolymer made by reacting the alicyclic isocyanate-type compound with the aromatic disulfide-type diol, and in addition thereto, any prepolymer may be used without particular limitation, so long as it includes the disulfide functional group (—Ar₁—S—S—Ar₂—) and the urethane bond, with isocyanate groups (—NCO) at both ends of the prepolymer.

Thereafter, an oligomer may be synthesized by reacting the prepolymer with the carbonate-type diol.

Subsequently, a polyurethane-based coating composition may be manufactured by mixing the main resin including the oligomer with the hardener including polyisocyanate.

The main resin may further include an organic solvent to more uniformly mix the oligomer and the hardener. The organic solvent may be used without particular limitation so long as it is commonly used in the art, and specific examples may include, but are not limited to, alcohol-based solvents such as methanol, ethanol, methoxyethanol, propanol, isopropanol, butanol, isobutanol, etc., acid solvents such as acetic acid, formic acid, etc., nitro-based solvents such as nitromethane, etc., ketone-based solvents such as acetone, methyl ethyl ketone, methyl isobutyl ketone, etc., ester-based solvents such as ethyl acetate, butyl acetate, 3-methoxy-3-methyl butyl acetate, propylene glycol monomethyl ether acetate, etc., amine-based solvents such as dimethylformamide, methyl pyrrolidone, dimethylacetamide, etc., ether-based solvents such as tetrahydrofuran, 2-methyl tetrahydrofuran, dimethyl ether, dibutyl ether, etc., and combinations thereof.

In addition, a polyurethane-based coating film may be manufactured by applying the polyurethane-based coating composition onto a coating material. The process of application of the coating composition may be performed without particular limitation so long as it is commonly used in the art, and examples thereof may include spray coating, doctor blade, die casting, comma coating, screen printing, etc. Preferably, the coating film is manufactured by applying the coating composition by spraying. This may be due to the fact that the coating composition according to the present disclosure exhibits excellent surface hardness and fluidity in a balanced manner and thus spray coating is possible.

The coating film according to the present disclosure may be manufactured by heat treating the coating composition applied onto the coating material. The heat treatment may be performed at a temperature of 60° C. to 100° C. for 12 to 48 hours. In this process, the organic solvent, etc. further included in the main resin may be removed.

A better understanding of the present disclosure may be obtained through the following examples and comparative examples. However, these examples are not to be construed as limiting the technical spirit of the present disclosure.

### Methods of Evaluation of Properties

The properties of a coating composition or a coating film manufactured below were measured by the following methods.
1) Self-healing efficiency (%): Self-healing efficiency is a value determined by forming a scratch with a width of 30 to 70 μm on the surface of a film-shaped coating composition or a coating film and then observing the recovered width by exposure to a temperature of 30° C. for 20 hours using an optical microscope.

$$Self - healing efficiency ( \% ) = ( width of scratch - width of scratch after self - healing ) / width of scratch \times 100$$

2) Transmission (%): Transmission is determined by placing a coating film on a clear slide glass, measuring the absorbance of the coating film at a wavelength of 500 nm using a UV-VIS spectrophotometer, and then converting the same into a transmission according to the following equation.

$$Transmission ( \% ) = ( {10}^{- absorbance} ) \times 100$$

3) Sagging (%): Sagging is determined by measuring a change in thickness at the bottom of the coating film after placing the coating film that is manufactured and dried at an angle of 60° followed by leaving at a temperature of 80° C. for one week.

Sagging (%)=(thickness of bottom of coating film after 7 days−thickness of bottom of initial coating film)/thickness of bottom of initial coating film×100

### Preparation Example—Synthesis of Oligomer

An oligomer included in the main resin was synthesized according to the manufacturing method of the present disclosure.

Specifically, 54.6 g of 0.068 mmol poly(hexamethylene carbonate) (HPCD) was purged at 100° C. for 1 hour to completely remove residual water therefrom. Then, the temperature was lowered to 80° C.

Thereafter, 15.17 g of 0.068 mmol isophorone diisocyanate (IPDI), 15.17 g of N,N-dimethylacetamide (DMAc), and 0.0885 g of 1000 ppm dibutyltin dilaurate (DBTDL) were added to a vial and reacted for 1 hour.

To a vial separate from the vial containing IPDI, 8.54 g of 0.034 mmol bis(4-hydroxyphenyl) disulfide, 17.08 g of DMAc, 0.0885 g of 1000 ppm DBTDL were added and stirred sufficiently.

The solutions in the vial containing IPDI and the vial containing disulfide were added to a round bottom flask (RBF) and reacted for 1 hour under nitrogen conditions, synthesizing a prepolymer.

The synthesized prepolymer solution was added to the purged HPCD and reacted for 1 hour, synthesizing an oligomer. The oligomer solution in which the synthesized oligomer was dispersed was completely dried in a vacuum oven at 110° C. to remove DMAc, thereby obtaining the oligomer according to the present disclosure.

Information on the compounds and diols used for oligomer synthesis is shown in Table 1 below.

TABLE 1
IPSS Oligomer

| | Ratio | g | mol | Mw (g/mol) |
|---|---|---|---|---|
| HPCD | 8 | 54.6 | 0.0546 | 1000 |
| IPDI | 10 | 15.17 | 0.068 | 222.29 |
| DBTDL | — | 0.177 | — | 631.56 |
| DMAc | — | 32.25 | — | — |
| Disulfide | 5 | 8.54 | 0.034 | 250.33 |

### Test Example 1—Calculation of Theoretical Ratio Between Synthesized Oligomer and Hardener

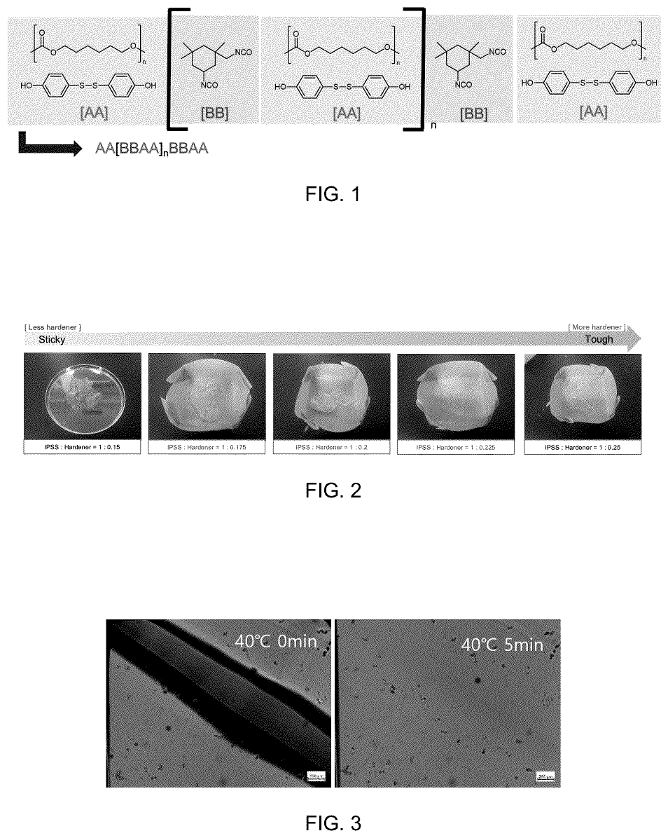

(1) In order to determine the ratio between the oligomer synthesized above and a hardener to be added to produce a polyurethane-based coating composition, the expected structural formula of the synthesized oligomer as shown in FIG. 1 was assumed.

Referring to Table 1, 8 equivalents of HPCD, 10 equivalents of IPDI, and 5 equivalents of disulfide were used to synthesize the oligomer. In classification depending on the functional group, respective proportions of a monomer having —OH group ([AA]) and a monomer having —NCO group ([BB]) may be represented as 13K and 10K. Here, K is the proportionality constant.

The average molecular weight of the monomer [AA] having the —OH group may be calculated to be about 712.65 g/mol, and the average molecular weight of the monomer [BB] having the —NCO group may be calculated to be about 222.29 g/mol. The expected structural formula of the synthesized oligomer with —OH groups at both ends by breaking stoichiometric balance may be represented by AA[BBAA]ₙBBAA. Here, [AA] has n+2=13K, and [BB] has n+1=10K. By solving the system of equations, the proportionality constant K may be determined to be ⅓ and the repeat unit n may be determined to be 2.333 . . . (7/3). Finally, when substituting the repeat unit n to the structural formula and also substituting each average molecular weight, the theoretical average molecular weight may be calculated to be 3826 g/mol.

The number of moles per g of the —OH group in the oligomer is 0.5227 mmol (0.5227 mmol/g) and the —OH group of the oligomer and —NCO of the hardener react at a ratio of 1:1, and thus the numbers of moles of the oligomer and the hardener required for complete hardening have to be equal.
(2) To this end, NCO titration of the hardener using hydrochloric acid may be performed as follows. NCO titration follows the ASTM D5155 test method, and a specific titration method is described below.

Specifically, about 0.5-1.0 g of a sample is added to an Erlenmeyer flask. 25 ml of toluene (or acetone) is added to the Erlenmeyer flask and mixed until the sample is dissolved. 25 ml of a 0.1 N dibutylamine solution is added and mixed for 15 minutes. 50 ml of isopropyl alcohol is added and a bromophenol blue indicator solution (blue) is added 6 drops. Titration is performed with 0.1 N hydrochloric acid until the yellow end point is reached. A blank test is performed in the same manner under the condition that no sample is added.

Based on results of NCO titration, 0.5062 g of the sample was titrated to the end point with 0.1 N hydrochloric acid, and 25.5 ml of hydrochloric acid (B) consumed in the blank sample and 12 ml of hydrochloric acid (V) consumed in sample titration were used. The molar mass of HCl used may be determined to be 2.6669 mmol/g using the following equation.

[Molar mass of HCl used to titrate sample (g)={(B−V)×N}/sample-gram]

Consequently, the amount of HCl used is the same as the amount of NCO used for urea reaction, confirming that 2.6669 mmol/g of the —NCO group is contained in 0.5062 g of the sample. Here, since NCO and OH react at 1:1, NCO has to be added in the same amount as 0.5227 mmol OH contained in 1 g of the oligomer. Accordingly, since the —NCO group amounts to 2.6669 mmol per g, the hardener has to be added in an amount of 0.1960 g as much as 0.5227 mmol (main resin:hardener=1:0.1960)
(3) The amount per g of the NCO functional group in a pure IPDI compound used to mix MDI contained in the hardener with another type of diisocyanate is (2*1 g)/(0.2223 g/mmol)=8.997 mmol/g, and thus the mass ratio of the IPDI alone to be added in an equivalent to the OH functional group of the main resin is as follows; main resin:IPDI=1:0.0581.

### Test Example 2—Numerical Range Derivation of Mass Ratio Between Main Resin and Hardener

In order to expand the theoretical mass ratio between the main resin and the hardener determined through the NCO titration to an appropriate numerical range, the main resin including the oligomer synthesized according to Preparation Example and the conventional MDI hardener (4,4′-diphenylmethane diisocyanate) were mixed at a mass ratio shown in Table 2 below, obtaining a coating composition.

Specifically, the C-IPSS oligomer (1 g, number of moles of [—OH]=0.5227 mmol) synthesized in Preparation Example was added to a commercial solvent (10-25 wt %) and completely dissolved through vortex at room temperature to afford a main resin (solvent composition=butyl acetate, propylene glycol monomethyl ether acetate, and methyl isobutyl ketone at a mass ratio of 25:65:10). For reference, hereinafter, the mass ratio of the main resin to the hardener indicates the mass ratio of the oligomer in the main resin to MDI, IPDI, or a mixture of MDI and IPDI in the hardener.

Thereafter, the hardener including MDI as the main ingredient was added to the polymer solution and thoroughly mixed for 1 minute, yielding each coating composition.

TABLE 2

| Composition | Main resin | Hardener (MDI) |
|---|---|---|
| 1 | 1 | 0.15 |
| 2 | 1 | 0.175 |
| 3 | 1 | 0.2 |
| 4 | 1 | 0.225 |
| 5 | 1 | 0.25 |

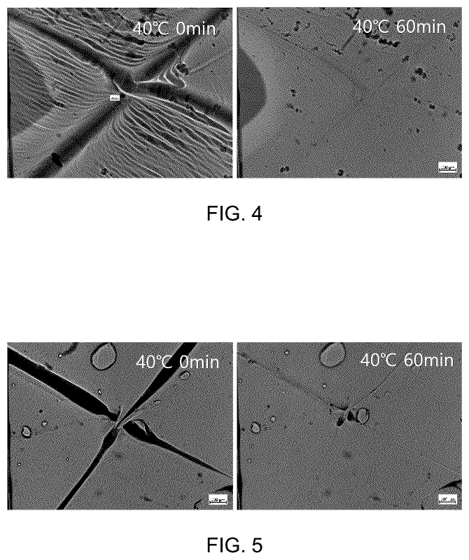

Thereafter, each prepared coating composition was applied in a predetermined amount onto the Petri dish and dried, as shown in FIG. 2. A scratch with a width of 30-70 μm was formed on the surface of the coating composition, left at 40° C. for 5 to 60 minutes, and observed using an optical microscope to determine whether the scratch disappeared. FIG. 3 shows results for the coating composition including the main resin and the hardener mixed at a mass ratio of 1:0.175, FIG. 4 shows results for the coating composition including the main resin and the hardener mixed at a mass ratio of 1:0.2, and FIG. 5 shows results for the coating composition including the main resin and hardener mixed at a mass ratio of 1:0.225.

Referring to FIGS. 3 to 5, all of compositions 2 to 4, in which the mass ratio of the main resin to the hardener is 1:0.175 to 1:0.225, had self-healing properties. In particular, for composition 2, all scratches disappeared in 5 minutes.

In contrast, composition 1, in which the mass ratio of the main resin to the hardener was 1:0.15, not shown separately, had self-healing properties but stickiness thereof was too high, particularly fluidity of the coating composition was low, making it difficult to use the same as a hardening paint. Also, composition 5, in which the mass ratio of the main resin to the hardener was 1:0.25, did not exhibit self-healing properties due to an excess of the hardener. Thereby, it was confirmed that the mass ratio of the main resin to the hardener has to be 1:0.16 to 1:0.24, preferably 1:0.175 to 1:0.225.

### Test Example 3—Self-Healing Ability Depending on Composition of Hardener and Thickness of Coating Film

(1) Each coating composition was prepared using MDI alone, IPDI alone, and a mixture of MDI and IPDI as the hardener under the condition that the mass ratio of the main resin to the hardener was fixed to 1:0.196, 1:0.0581, and 1:0.1271. Thereafter, a coating film was manufactured by applying the coating composition onto a glass plate. A specific manufacturing method thereof is described below.

Specifically, the C-IPSS oligomer (1 g, number of moles of [—OH]=0.5227 mmol) synthesized in Preparation Example was added to a commercial solvent (10-25 wt %) and completely dissolved through vortex at room temperature (commercial solvent composition=butyl acetate, propylene glycol monomethyl ether acetate, and methyl isobutyl ketone at a mass ratio of 25:65:10).

Thereafter, a hardener including MDI, IPDI, or a mixture thereof as the main ingredient was added to the polymer solution and mixed thoroughly for 1 minute to afford a coating composition. Here, MDI or IPDI was added so that the number of moles of [—NCO] in the hardener and the number of moles of [—OH] in the oligomer were equal to each other. The relative molar ratio and mass ratio of MDI and IPDI in the coating composition are listed in Table 3 below.

The coating composition thus obtained was applied onto a glass plate by spraying. Here, spray coating was performed to a coating thickness shown in Table 3 below at a spray speed of 5 psi using a compressor (BEETLE BUG, BBT-001). Thereafter, the coating film was manufactured by drying in an oven at 80° C. for one day.

TABLE 3

| | | Hardener | | Hardener | | | |
|---|---|---|---|---|---|---|---|
| Coating | Main | (molar ratio) | | (mass ratio) | | Thickness of | |
| film | resin:hardener | MDI | IPDI | MDI | IPDI | coating film | |
| 1 | 1:0.1960 | 100 | 0 | 100 | 0 | 35-45 | μm |
| 2 | 1:0.1960 | 100 | 0 | 100 | 0 | 70-90 | μm |
| 3 | 1:0.1960 | 100 | 0 | 100 | 0 | 105-135 | μm |
| 4 | 1:0.0581 | 0 | 100 | 0 | 100 | 35-45 | μm |
| 5 | 1:0.0581 | 0 | 100 | 0 | 100 | 70-90 | μm |
| 6 | 1:0.0581 | 0 | 100 | 0 | 100 | 105-135 | μm |
| 7 | 1:0.1271 | 50 | 50 | 100 | 88.84 | 35-45 | μm |
| 8 | 1:0.1271 | 50 | 50 | 100 | 88.84 | 70-90 | μm |
| 9 | 1:0.1271 | 50 | 50 | 100 | 88.84 | 105-135 | μm |

(2) The self-healing properties of the coating film manufactured as above were confirmed. Also, in the same hardener composition, the self-healing properties were confirmed by varying the thickness of the coating film as shown in Table 3. Furthermore, to determine changes in self-healing properties depending on temperature, self-healing properties were confirmed at 30° C., 40° C., 50° C., and 60° C.

### 1) Coating Films 1 to 3 (Hardener=MDI)

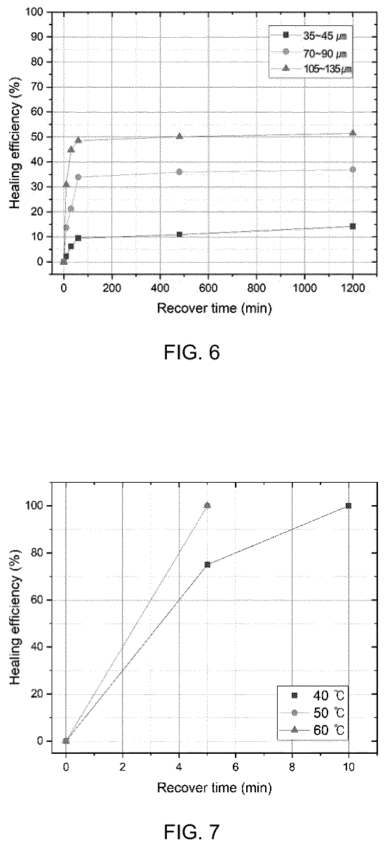

Table 4 below and FIG. 6 show results of the self-healing time and self-healing efficiency of coating films 1 to 3 using only MDI as the main ingredient of the hardener.

TABLE 4

| | | | | | | |
|---|---|---|---|---|---|---|
| Thickness | 35-45 | μm | 70-90 | μm | 105-135 | μm |
| Healing time | 1200 | min | 1200 | min | 1200 | min |

| | | | |
|---|---|---|---|
| Self-healing efficiency | 14% | 36% | 51% |

According to Table 4 and FIG. 6, coating films 1 to 3 exhibited slow self-healing properties only at high temperatures of 60° C. or more and did not exhibit complete recovery. Moreover, self-healing properties were not fully exhibited at 30° C. to 50° C. Also, the self-healing efficiency increased with an increase in the thickness of the coating film.

### 2) Coating Films 4 to 6 (Hardener=IPDI)

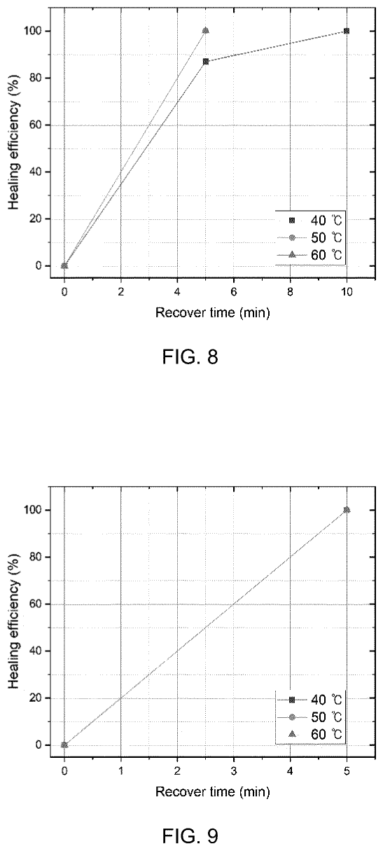

Table 5 below shows results of measurement of the self-healing time and self-healing efficiency of coating films when using only IPDI as the main ingredient of the hardener and varying the thickness and temperature of the coating film. In addition, FIG. 7 shows results of the self-healing time and self-healing efficiency of coating film 4, FIG. 8 shows results of the self-healing time and self-healing efficiency of coating film 5, and FIG. 9 shows results of the self-healing time and self-healing efficiency of coating film 6.

TABLE 5

| | | | | | Self-healing |
|---|---|---|---|---|---|
| Coating | Thickness | | Temperature | Healing time | efficiency |
| film | (μm) | | (° C.) | (min) | (%) |
| 4 | 35-45 | μm | 30 | 10 | 100 |
| | | | 40 | 10 | 100 |
| | | | 50 | 5 | 100 |
| | | | 60 | 5 | 100 |
| 5 | 70-90 | μm | 30 | 10 | 100 |
| | | | 40 | 10 | 100 |
| | | | 50 | 5 | 100 |
| | | | 60 | 5 | 100 |
| 6 | 105-135 | μm | 30 | 10 | 100 |
| | | | 40 | 5 | 100 |
| | | | 50 | 5 | 100 |
| | | | 60 | 5 | 100 |

Referring to Table 5 and FIGS. 7 to 9, when IPDI was used alone as the main ingredient of the hardener, very fast self-healing properties were exhibited compared to when MDI was used alone. However, the use of IPDI alone was disadvantageous in that it was difficult to maintain the hardened form due to excessive sagging or fluidity of the coating composition.

### 3) Coating Films 7 to 9 (Hardener=MDI+IPDI)

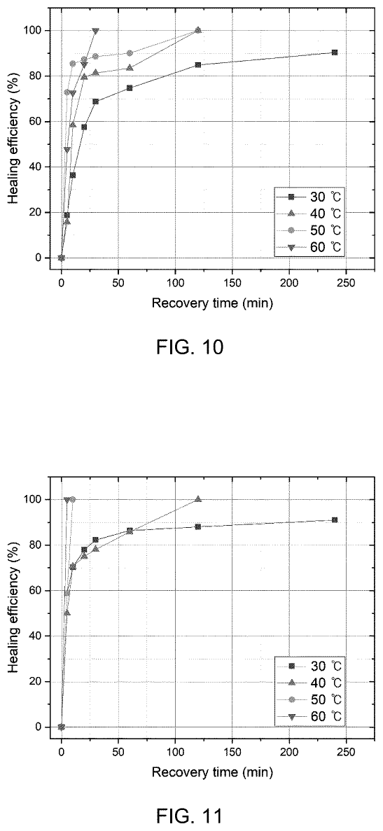

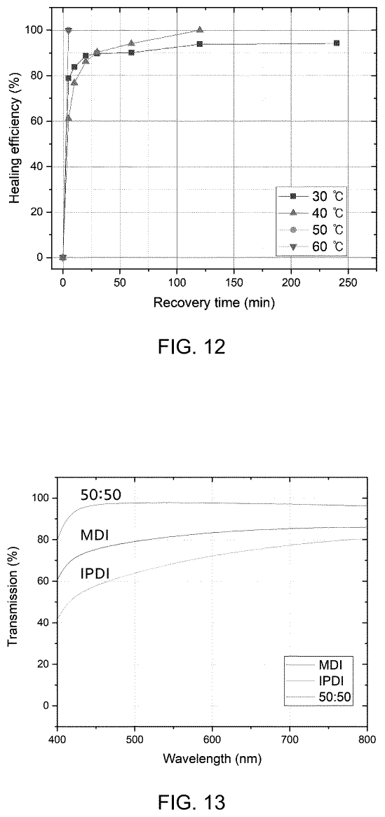

Table 6 below shows results of measurement of the self-healing time and self-healing efficiency of coating films when using a mixture of MDI and IPDI at a weight ratio of 1:1 as the hardener and varying the thickness and temperature of the coating film. In addition, FIG. 10 shows results of the self-healing time and self-healing efficiency of coating film 7, FIG. 11 shows results of the self-healing time and self-healing efficiency of coating film 8, and FIG. 12 shows results of the self-healing time and self-healing efficiency of coating film 9.

TABLE 6

| | | | | | Self-healing |
|---|---|---|---|---|---|
| Coating | Thickness | | Temperature | Healing time | efficiency |
| film | (μm) | | (° C.) | (min) | (%) |
| 7 | 35-45 | μm | 30 | 1200 | 90 |
| | | | 40 | 120 | 100 |
| | | | 50 | 120 | 100 |
| | | | 60 | 120 | 100 |
| 8 | 70-90 | μm | 30 | 1200 | 91 |
| | | | 40 | 120 | 100 |
| | | | 50 | 10 | 100 |
| | | | 60 | 5 | 100 |
| 9 | 105-135 | μm | 30 | 1200 | 94 |
| | | | 40 | 120 | 100 |
| | | | 50 | 5 | 100 |
| | | | 60 | 5 | 100 |

Referring to Table 6 and FIGS. 10 to 12, for a thickness of 35 to 45 μm, self-healing performance was determined to be 90% in 20 hours at 30° C., 100% in 2 hours at 40° C., 100% in 2 hours at 50° C., and 100% in 30 minutes at 60° C.

For a thickness of 70-90 μm, the healing performance was determined to be 91% in 20 hours at 30° C., 100% in 2 hours at 40° C., 100% in 10 minutes at 50° C., and 100% in 5 minutes at 60° C.

For a thickness of 105-135 μm, the healing performance was determined to be 94% in 20 hours at 30° C., 100% in 2 hours at 40° C., 100% in 5 minutes at 50° C., and 100% in 5 minutes at 60° C.

Like the other samples, the MDI: IPDI (50:50) sample had higher self-healing efficiency with increases in thickness and temperature, and showed balanced properties that alleviated the disadvantages when using MDI/IPDI alone.

### Test Example 4—Self-Healing Ability, Transmission, and Sagging of Coating Films Depending on Various Hardener Compositions

In order to more specifically determine the self-healing ability, transmission, and sagging of the coating film depending on the composition of the hardener, a coating film was manufactured in the same manner as in Test Example 3, with the exception that the composition of the hardener was set as shown in Table 7 below and the coating composition was applied and dried so that the thickness of the coating film was about 80 μm. Thereafter, self-healing efficiency, transmission, and sagging were measured as described in the “Methods of evaluation of properties” above, and the results thereof are shown in Table 7 below. Also, the transmission of coating films 10, 13, and 14 is graphed in FIG. 13.

TABLE 7

| | | | Self-healing | | |
|---|---|---|---|---|---|
| Coating | MDI:IPDI | Thickness | efficiency | Transmission | Sagging |
| film | (mass ratio) | (μm) | (%) | (%) | (%) |
| 10 | 50:50 | 80 | 94 | 98 | 0.0 |
| 11 | 70:30 | 80 | 81 | 91 | 0.0 |
| 12 | 30:70 | 81 | 98 | 86 | 4.9 |
| 13 | 100:0 | 78 | 0 | 79 | 0.16 |
| 14 | 0:100 | 82 | 100 | 63 | 13.4 |

Referring to Table 7, coating films 10 to 12, in which the mass ratio of MDI to IPDI was set to 70:30 to 30:70, had self-healing efficiency (at room temperature), transmission, and sagging, all of which were excellent in a balanced manner. In contrast, coating films 13 and 14, in which the mass ratio of MDI to IPDI in the hardener fell outside 70:30 to 30:70, did not exhibit self-healing properties at room temperature or had too high sagging, making it difficult to maintain the hardened form.

Moreover, coating films 13 and 14 had low transmissions of 80% or less in common.

As described above, the polyurethane-based coating composition according to the present disclosure includes an oligomer that is a polymer of a carbonate-type diol, an alicyclic isocyanate-type compound, and an aromatic disulfide-type diol, and thus exhibits self-healing properties at room temperature without additional heat treatment or light irradiation.

Also, the coating composition according to the present disclosure exhibits self-healing properties and is not excessively sticky by setting the molar ratio of the main resin and the 15 hardener in a predetermined range.

Moreover, since the hardener of the coating composition according to the present disclosure includes a mixture of MDI and IPDI at a predetermined weight ratio, excellent fluidity and surface hardness are exhibited in a balanced manner without an excessive increase in the thickness of the coating film even at room temperature.

Therefore, it is possible to form a coating film by applying the polyurethane-based coating composition according to the present disclosure onto a coating material by spraying.

As is apparent from the above description, a polyurethane-based coating composition according to the present disclosure includes an oligomer that is a polymer of a carbonate-type diol, an alicyclic isocyanate-type compound, and an aromatic disulfide-type diol, and can thus exhibit self-healing properties at room temperature without additional heat treatment or light irradiation.

In addition, the polyurethane-based coating composition according to the present disclosure can exhibit excellent fluidity and surface hardness in a balanced manner without an excessive increase in the thickness of a coating film.

Accordingly, a coating film can be formed by applying the polyurethane-based coating composition onto a coating material by spraying.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A polyurethane-based coating composition, comprising:
a) a resin comprising an oligomer comprising a disulfide functional group (R—S—S—R′) and a hydroxyl group (—OH), wherein R and R′ are each independently a substituted or unsubstituted C6-C30 arylene group; and
b) a hardener comprising polyisocyanate.

2. The polyurethane-based coating composition of claim 1, wherein the oligomer comprises a polymer of a carbonate-type diol, an alicyclic isocyanate-type compound, and an aromatic disulfide-type diol.

3. The polyurethane-based coating composition of claim 1, wherein the oligomer is represented by Chemical Formula 1 below: 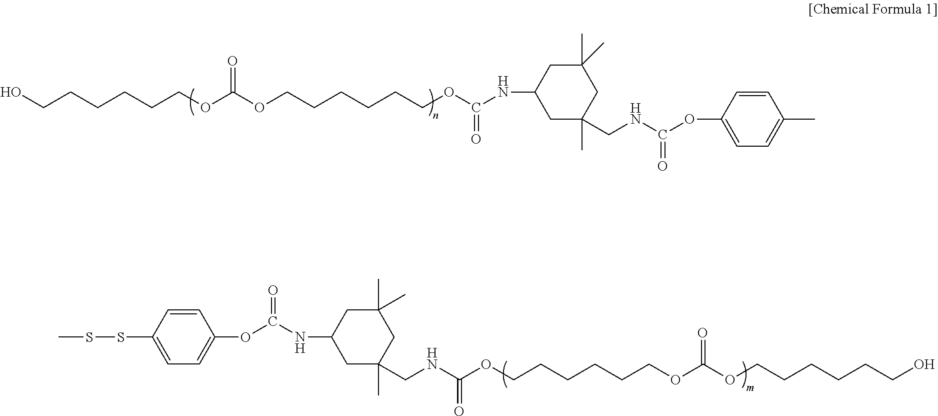
wherein n and m are integers of 1 or more indicating repetition numbers of respective repeat units.

4. The polyurethane-based coating composition of claim 2, wherein a molar ratio ([—OH]/[—NCO]) of a hydroxyl group (—OH) of the carbonate-type diol and the aromatic disulfide-type diol to an isocyanate group (—NCO) of the alicyclic isocyanate-type compound satisfies about 1.05≤[—OH]/[—NCO]≤about 1.5.

5. The polyurethane-based coating composition of claim 2, wherein the carbonate-type diol has a number average molecular weight of about 500 to about 5,000 g/mol.

6. The polyurethane-based coating composition of claim 2, wherein the aromatic disulfide-type diol is represented by Chemical Formula 2 below: 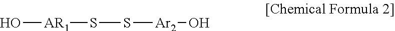
wherein in Chemical Formula 2, Ar₁ and Ar₂ are each independently a substituted or unsubstituted C6-C30 arylene group.

7. The polyurethane-based coating composition of claim 2, wherein the alicyclic isocyanate-type compound comprises any one selected from the group consisting of isophorone diisocyanate, 4,4′-dicyclohexylmethane diisocyanate, cyclohexylene diisocyanate, methylcyclohexylene diisocyanate, bis(2-isocyanatoethyl)-4-dichlorohexene-1,2-dicarboxylate, 2,5-norbornane diisocyanate, 2,6-norbornane diisocyanate, and combinations thereof.

8. The polyurethane-based coating composition of claim 1, wherein a molar ratio ([—OH]/[—NCO]) of a hydroxyl group (—OH) of the resin to an isocyanate group (—NCO) of the hardener satisfies about 0.9≤[—OH]/[—NCO]≤about 1.1.

9. The polyurethane-based coating composition of claim 1, wherein the polyurethane-based coating composition comprising the resin and the hardener at a mass ratio of about 1:0.16 to about 1:0.24.

10. The polyurethane-based coating composition of claim 1, wherein the hardener comprises methylene diphenyl diisocyanate and isophorone diisocyanate.

11. A polyurethane-based coating film, comprising the polyurethane-based coating composition of claim 1.

12. The polyurethane-based coating film of claim 11, wherein the polyurethane-based coating film has a self-healing efficiency of about 80% or more as represented by Equation 1 below:
$$Self - healing efficiency ( \% ) = ( width of scratch - width of scratch after self - healing ) / width of scratch \times 100. \qquad [ Equation 1 ]$$

13. The polyurethane-based coating film of claim 11, wherein the polyurethane-based coating film has a transmission of about 85% or more as represented by Equation 2 below:
$$Transmission ( \% ) = ( {10}^{- absorbance} ) \times 100 \qquad [ Equation 2 ]$$

14. The polyurethane-based coating film of claim 11, wherein the polyurethane-based coating film has a sagging of about 5% or less as represented by Equation 3 below:
$$Sagging ( \% ) = ( thickness of bottom of coating film after 7 days - thickness of bottom of initial coating film ) / thickness of bottom of initial coating film \times 100 \qquad [ Equation 3 ]$$

15. A polyurethane-based coating composition, comprising:
a resin comprising an oligomer comprising a disulfide functional group and a hydroxyl group; and
a hardener comprising polyisocyanate,
wherein the oligomer comprises a polymer of poly(hexamethylene carbonate), bis(4-hydroxylphenyl) disulfide,
wherein the hardener comprising methylcyclohexylene diisocyanate, and isophorone diisocyanate, and
wherein a mass ratio of methylcyclohexylene diisocyanate to isophorone diisocyanate is about 7:3 to 3:7.

16. A polyurethane-based coating composition of claim 1 wherein the composition comprises:
a resin comprising an oligomer comprising a disulfide functional group (R—S—S—R′) and a hydroxyl group (—OH); and
a hardener comprising polyisocyanate,
wherein R and R′ are each independently a substituted or unsubstituted C6-C30 arylene group,
wherein the oligomer comprises a polymer of a carbonate-type diol, an alicyclic isocyanate-type compound, and an aromatic disulfide-type diol,
wherein a molar ratio ([—OH]/[—NCO]) of a hydroxyl group (—OH) of the carbonate-type diol and the aromatic disulfide-type diol to an isocyanate group (—NCO) of the alicyclic isocyanate-type compound satisfies about 1.05≤[—OH]/[—NCO]≤about 1.5, and wherein a molar ratio ([—OH]/[—NCO]) of a hydroxyl group (—OH) of the resin to an isocyanate group (—NCO) of the hardener satisfies about 0.9≤[—OH]/[—NCO]≤about 1.1.

17. A method of manufacturing a polyurethane-based coating film, comprising applying the polyurethane-based coating composition of claim 1 by spraying.

18. A method of manufacturing a polyurethane-based coating composition, comprising:
preparing a carbonate-type diol, an alicyclic isocyanate-type compound, and an aromatic disulfide-type diol;
synthesizing a prepolymer by reacting the alicyclic isocyanate-type compound with the aromatic disulfide-type diol;
synthesizing an oligomer by reacting the prepolymer with the carbonate-type diol; and
manufacturing a polyurethane-based coating composition by mixing a resin comprising the oligomer with a hardener comprising polyisocyanate.

19. The method of claim 18, wherein synthesizing the prepolymer comprises reacting a first solution comprising the alicyclic isocyanate-type compound, dibutyltin dilaurate, and dimethylacetamide with a second solution comprising the aromatic disulfide-type diol, dibutyltin dilaurate, and dimethylacetamide.

20. The method of claim 18, wherein the prepolymer is represented by Chemical Formula 3 below: [chemical structure]
